(19) United States
(12) Patent Application Publication
(10) Pub. No.: US 2005/0015805 A1
(43) Pub. Date: Jan. 20, 2005

(54) Power line home network

(75) Inventor: Ryuichi Iwamura, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: SONY CORPORATION; SONY ELECTRONICS INC.

(21) Appl. No.: 10/723,079

(22) Filed: Nov. 25, 2003

Related U.S. Application Data
(60) Provisional application No. 60/488,518, filed on Jul. 17, 2003.

(51) Int. Cl. H04N 7/18

(52) U.S. Cl. 725/79; 725/80; 725/82

(57) ABSTRACT

A system for controlling video and audio devices distributed over a power-line communications (PLC) network. Streaming video and/or audio is communicated between media devices interfaced with a power-line communications (PLC) network. The devices are typically controlled by a media server which is preferably configured for receiving commands from a user utilizing a remote control unit, wherein commands are received by a media device, and certain commands which are not directed at that media device are passed through the media device to the media server for controlling the action of other media devices. The server supports adjusting encoding and/or decoding latency for synchronizing streams being input or output on media devices. Locking functions and password control features are provided for limiting control or dissemination of content. Rate control is preferably provided for limiting bandwidth utilization by streams, and a room-to-room live pause feature to prevent loss due to interruptions.

### CROSS-REFERENCE TO RELATED APPLICATIONS

This application claims priority from U.S. provisional application Ser. No. 60/488,518 filed on Jul. 17, 2003, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to media communication networks, and more particularly to communicating video and audio streams over power-line communication networks.

2. Description of Related Art

Intense competition in the home audio and video system market continues to drive industry innovation. Connectivity between devices is becoming an increasingly important aspect of that competition. Consider, for example, the increasing adoption of large flat panel display television sets. To provide space saving on these large planar units, users often purchase them for hanging, such as against a wall. However, in order to use the unit it must be connected to other devices, such as an antenna cable, and other peripheral audio/video devices (i.e. a PVR, DVD recorder/player, VCR, PC). Due to the various form factors of media receptacles, control inputs, and other aspects of the electronics, incorporating these elements with the flat panel display is rarely practical.

A realistic solution is a separate box that includes tuners and audio/video ports to connect to the television with interface cables. Routing of interface cables is both tedious and generally considered unattractive. As a result, the clean elegance, simplicity and aesthetics of the flat panel display are disrupted by the need for connectivity. Another issue is how to connect various sources to the television set (or other video and/or audio unit). Users may desire to view content from a number of alternative sources, such as contents stored in PC, DVD recorder, DV camera recorder, broadcast/cable/satellite network programming, and so forth. It is costly for a user to purchase a full suite of video and/or audio source units for each television set, consequently the source may be located in a different room from the television set.

The use of wireless networking has been proposed as one solution to the connectivity problem between audio and/or video devices, such as for routing source content to a television set. One such wireless network is defined by the 802.11a/b/g standard, generally known as the WiFi standard. Employing wireless connectivity between servers and portable laptops provides a viable networking solution, however, the wireless solution is not ideally suited for use in connecting a plurality of non-portable stream-based video and/or audio devices. Utilizing wireless networking for a streaming application, such as content connectivity to a television set and/or to and from other video and audio units, is subject to a number of disadvantages, including the following. (1) The signal reach of wireless connectivity is limited (especially at full bandwidth). (2) Antennas are required at the source and destination ends of the communication path. (3) Typically insufficient bandwidth exists for providing connectivity for all audio and video devices within an environment, such as a home. (4) Wireless connectivity increases per unit cost, in particular when it must be incorporated within each device.

Therefore, a need exists for providing low-cost connectivity between devices for inputting, recording, playing back, or outputting of video and/or audio streams. The present invention satisfies those needs, as well as others, and overcomes the deficiencies of previously developed connectivity solutions.

### BRIEF SUMMARY OF THE INVENTION

A distributed video and/or audio system is described by the present invention wherein components are connected to one another over a power-line communications (PLC) interface and device operation orchestrated by one or more servers which are also connected over the PLC. The system provides a number of advantages over both traditionally wired interconnections and wireless connectivity.

The system is configured for allowing indirect remote control operations which pass through a remote enabled media device to a server. All or a selected portion of the commands generated from the remote control device transmitted from a receiving device, such as a television configured for remote control operation, to a server which can employ the commands for controlling its own actions and/or that of other devices under the direction of the server, such as video and/or audio devices connected to the PLC or even devices controlled through either wired or wireless connectivity.

Devices to be controlled within the system need not be controlled over the PLC, as the system can convert commands from one communication form to another. One example of this mode of operation is the control of devices, such as legacy VCRs, DVR, and so forth which are connected remotely to the server and controlled through their own IR port by an IR mouse controlled by the server. Wherein commands can be communicated to the server through a remote controlled device configured for passing selected commands through to the server over the PLC.

Considering an example within a household, a remote control may be operated in the living room directed at a television set. A portion of the commands emanating from the remote control unit can be interpreted by the television for controlling aspects of local viewing, for example, audio volume, mute, channel and so forth. Other commands sent from the remote are transmitted by the television set over the PLC network to other devices. Preferably, the commands are received over the PLC by a server which can interpret the commands and control operational aspects of other devices within the system.

In general, the system allows rerouting of remote control signals, such as from an infrared (IR) remote control transmitter to a server connected over the PLC network. Control signals from remote controls are routed from a receiving device, such as a television, to a server. Generally only selected control signals are routed, with device specific signals such as volume being responded to directly by the receiving device.

Commands from the system may be communicated to video and/or audio devices (i.e. legacy video and/or audio devices) by interface devices configured to communicate in accord with a given device. An example of this is utilizing an IR output module which operates as an interface, such as receiving commands from a server, either directly or through the PLC interface, and converting those commands into an infrared output to a VCR, DVD, or similar. In this way the server can manipulate the operations of a device which is not configured to communicate either directly with the server or through a PLC.

The system preferably provides a mechanism for adjusting decoding latency when coordinated output is desired for two or more devices connected to the system. It will be appreciated that when devices perform their own PLC-to-video or audio conversion, the playback of video and audio over different devices could become out of synch, for example sound being generated from a speaker device before the associated video is displayed on a television device. The system is configured to allow adjusting the decoding latency of devices, such as speakers, wherein the decoding latency is adjusted to match that of the video output device. The system optionally provides for adjusting encoding latency wherein two channels of input may be synchronized, such as during recording.

Another beneficial feature of the system is that of providing rate control by the server, wherein the bandwidth utilized by a particular device is altered, such as by the server, in response to the changes in bandwidth utilization, for example adding another stream to be communicated over the PLC between devices. Examples of changing bandwidth utilization include the following scenarios. (1) In response to changes in available PLC bandwidth (from server monitoring of PLC bandwidth availability) the rate at which video (and/or audio) is output to the user is altered. For example, gracefully reducing the bandwidth of the video signal to conserve PLC bandwidth. (2) To support picture-in-picture (PnP) the output device can command the server on the data rates desired for each stream.

The system can provide parental control of viewing (and/or audio) as controlled through the server. A parent can set limitations on what sources can be displayed over which output device, and additionally, source selection can be controlled by a password, a biometric identifier, or any other convenient means (also referred to herein as access tokens) for providing identification of individuals or classes of users.

The system provides for controlling the communication of video or audio with devices connected over the PLC. A wide variety of devices may be connected over the PLC communication interface to the system, including television sets, speakers, VCRs, digital video recorders, video cameras, audio cameras, and so forth. Multiple elements are controlled by one or more servers which contain programming for carrying out operations according to the present invention.

Server routing of video and/or audio source can also be performed within the present system. Video communication channels (i.e. over aerial, cable, or modem) are input to the video server which routes the signals over the PLC, or other form of communications link, such as IEEE 1394, to the receiving device which for example may comprise a television, PVR, or similar.

Communicating command and media streams through the power line opens up additional applications and convenience features. For example, a PLC-adapted AC adapter can be configured according to the present invention, wherein the AC adapter operates for both powering the device (i.e. camera, microphone, PDA, laptop, etc.) and providing communication between the device and other devices connected on the PLC network. The AC adapter incorporates a power supply configured for converting AC line power to a suitable format for use by a portable electronics device, such as regulating allowable voltage, current, and supply ripple.

Detection and selection of sources can be performed within the present system. This feature allows all available video sources (and/or audio sources, multimedia sources, and so forth) to be detected whereby information can be generated for display on a video display/television, or other form of output. Detection of the devices and collection of device information is preferably performed according to the plug-in-play standard (PinP), or any other convenient mechanism for automating device connectivity.

Devices may be selected upon which outputs are to be directed (or inputs selected from). For example, the user can select an output device by sending commands to the server, such as commands from an IR remote control unit to the television which is sent to the server to control which speakers to use for playing the source.

The PLC to which the present system is connected preferably contains a means for isolating this virtual network portion of the power-line communications network from other virtual network portions (i.e. other households) sharing a single-physical-power line distribution transformer. This may be accomplished utilizing a filter connected to the power line for isolating one PLC portion from another.

By way of example and not of limitation, other forms of isolation can be additionally, or alternatively utilized with the present invention such as encrypting data within each virtual network, and communicating over the PLC network within channel assignments.

An aspect of the invention provides for the distributed control of video and audio components (media devices) over a power-line communications network.

An aspect of the invention provides for a flexible media distribution layout, which for example can simplify stream connectivity for flat panel televisions, such as may be mounted upon a wall.

Another aspect of the invention is a method of controlling video and/or audio inputs and outputs from distributed media devices with commands passing over a PLC to which said media devices are connected.

Another aspect of the invention is a server connected to the power-line communications network for coordinating the operation of devices and passing video and audio streams to and from device.

Another aspect of the invention is programming on the server which is configured to automatically adjust encoding and/or decoding latency for synchronized stream input and/or output to, or from, devices.

Another aspect of the invention is programming on the server for responding to selected remote control commands which are received by a device connected to the PLC and passed through the PLC to a device, or more preferably said server, for controlling operating aspects.

Another aspect of the invention is a method of controlling the playback of broadcast or recorded program content in response to device location and/or password control.

Another aspect of the invention is an AC power-adapter configured with PLC connectivity which provides power and communication signals to units such as cameras, PDAs, and other portable equipment.

Another aspect of the invention is the configuration of a wide variety of video and or audio media devices for use over the distributed PLC network.

Another aspect of the invention is translation interfaces for controlling the operation of media devices not configured for communication over a power-line communication network.

Another aspect of the invention is a translation interface that receives commands over the PLC or directly from devices, such as the server, and generates infrared output signals for controlling video and audio devices.

Another aspect of the invention is providing plug-in-play connectivity, wherein information about devices connected to the PLC network is automatically collected to configured the system.

Another aspect of the invention is the ability to provide flexible control for main and background media operations.

Another aspect of the invention is to provide transparent networks by bridging different network types, such as PLC and IEEE 1394, or PLC and wireless (i.e. 802.11a/b/g).

Another aspect of the invention is providing rate control of audio and video streams based on user configurations.

Another aspect of the invention is providing a configurable parental control.

Another aspect of the invention is providing multiple levels of parental control.

Another aspect of the invention is providing a room-to-room live pause feature so that viewing interruptions do not equate to being prevented from watching portions of a program.

Another aspect of the invention is support for legacy analog devices, such as video or audio components which may still be located remotely.

Another aspect of the invention provides expandability, wherein devices may be added to (or removed) from the system without the need to perform manual configurations of the network.

A still further aspect of the invention is translation interfaces for controlling the operation of devices not configured for communication over a power-line communication network.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a power-line network according to an embodiment of the present invention showing interconnected video and audio devices along with a server.

FIG. 2 is a block diagram of a server according to an embodiment of the present invention, shown with multiple audio and video inputs and outputs, IR interface modules and a PLC interface.

FIG. 3 is a block diagram of a multiplexer according to an aspect of the present invention.

FIG. 4 is a block diagram of television circuitry according to an aspect of the present invention, shown with a PLC interface through which control commands and/or content streams may be received.

FIG. 5 is a block diagram of a monophonic speaker unit according to an aspect of the present invention, shown with a PLC interface through which audio is received for output from the speaker.

FIG. 6 is a block diagram of a stereophonic speaker unit according to an aspect of the present invention, shown with a PLC interface through which audio is received for output from the speakers.

FIG. 7 is a block diagram of a DVD recorder according to an aspect of the present invention, shown with a disk media onto which content may be recorded as received over wired or wireless connections.

FIG. 8 is a block diagram of an AC adapter according to an aspect of the present invention, shown incorporating a PLC interface configured for communicating commands and video/audio streams.

FIG. 9 is a block diagram of a PLC interface circuit configured for use with a legacy analog television set according to an aspect of the present invention.

### DETAILED DESCRIPTION OF THE INVENTION

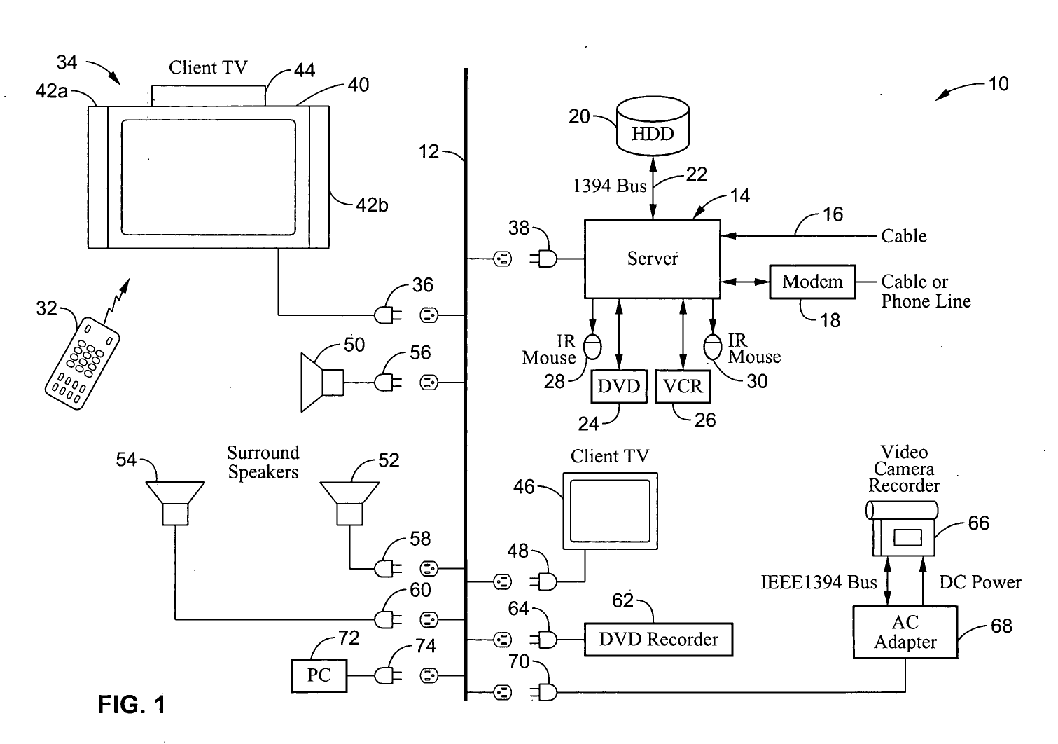

Referring more specifically to the drawings, for illustrative purposes the present invention is embodied in the apparatus generally shown in FIG. 1 through FIG. 9. It will be appreciated that the apparatus may vary as to configuration and as to details of the parts, and that the method may vary as to the specific steps and sequence, without departing from the basic concepts as disclosed herein.

1. Power Line Network.

FIG. 1 exemplifies distributed control 10 of video and audio components (media devices) which transmit and/or receive content over a segment (virtual power-line communications network) within a power-line communications network 12, such as one providing connectivity between the AC power outlets located within the rooms of a residential dwelling. One substantial advantage of this approach is that typical devices utilized within a home or office setting are already configured for connection to an AC receptacle for receiving operating power. Communicating over a PLC network also provides flexibility with regard to device placement, because the device may be connected to any location, insofar as an AC receptacle is within reach.

1.1 Streaming Devices Connected Over a Power Line Network.

Devices in the figure are shown within a home by way of example, it should be appreciated that more or fewer devices may be connected and that a variety of devices may communicate utilizing the present inventive methods over the power line network.

1.1.1 Server.

In the figure server 14 receives a signal from a video content source 16, such as a television cable connection, satellite feed, broadcasting antenna, and so forth. Additionally, or alternatively, data is received from a network access point, or similar, such as internet data received from a modem 18, which for example preferably comprises a cable modem, ADSL telephone line modem, wired network, wireless network, and so forth.

A media storage element 20 is exemplified as a hard-disk drive (HDD) which is connected to server 14 by any convenient means, such as utilizing an IEEE 1394 cable 22. An alternative embodiment can be created by integrating hard-disk 20 within server 14. By way of example HDD 20 records a stream sent from server 14, and/or sends a playback stream to server 14.

The system is also preferably configured to allow controlling devices which do not incorporate a PLC interface. By way of example, legacy DVD Player 24 and VCR 26 are shown connected to server 14. These legacy units are depicted connected to the server, such as with analog inputs and outputs, and having infrared control ports originally intended for receiving commands from a user-held remote control device. In the embodiment shown, a pair of infra-red output modules 28, 30 (IR mice) are connected which convert command signals from the server into infrared signals directed at the legacy devices, thereby providing a control interface to the legacy units.

Although shown connected for receiving control signals from the server, the interface units could be configured with integrated PLC interfaces over which they receive commands which are to be converted to IR signals (or any selected output signals) for communicating with devices that do not support the PLC interface. Consider the case where server 14 receives a remote command from another device, such as from remote control unit 32 as received by television 34 and forwarded through power-line connection 36 to PLC network 12 and through the AC connection 38 to server 14. If the commands are interpreted by server 14 as being control commands for the VCR, then the signals are routed out to IR mouse 30 which is optically coupled to the input of VCR 26, which executes the desired command, such as starting playback or recording, pausing, fast-forward, or other VCR-supported command. A television 34 is shown exemplified with a main decoder/display body 40, the front left speaker 42a, the front right speaker 42b, and the center speaker 44. Television 34 operates as a client of server 14 and receives audio/video streams from the server in response to exchanges of commands and data over PLC 12.

Utilizing the PLC as a network, it should be appreciated that server 14 need not be placed adjacent to television 34. For instance, server 14 may be placed near the cable terminal in a first room, while client television 34 is placed in another room, such as a family room. A second client television 46 connected through AC connection 48 is depicted in the block diagram, such as would typically be found in a bedroom, kitchen, gym, garage, and so forth. It should be appreciated that various televisions may be connected to the PLC which may provide different functionality, form factor, or applicability, such as portable devices, devices with supersets or subsets of the functionality provided by other units.

It should be recognized that at least one PLC ready media device, and typically a plurality of said devices, would be coupled to the server over the PLC network. The media device may be generally selected from the group of media devices consisting essentially of television sets, video monitors, audio systems, surround sound systems, speakers, computer devices, personal computers, video and/or audio recording units, video and/or audio playback units, still image capture or playback units, AC adapters configured for communicating with a media device coupled to said AC adapter, other device configured for manipulating video and/or audio, and combinations thereof.

It is preferred that server 14 and all devices connecting to the server over the PLC network be configured to allow the server to gather information from the device regarding operational features and supported commands.

1.1.2 Client Speakers.

Audio output transducers 50, 52, 54 (speakers) are shown connected via AC connections 56, 58, 60. It will be appreciated that although schematic symbols for speaker cones are shown, the speakers operating from the power line incorporate additional circuitry beyond simply one or more audio transducers (i.e. electromagnetic speaker, piezoelectric transducer, and so forth). Preferably the circuitry comprises circuits for decoding the audio signals from the power-line signal and for driving an audio transducer with analog signals (i.e. class A, B, or C amplification) or for driving the audio transducer with digital signals (i.e. Class D). Each speaker preferably also includes a power supply for converting AC input power to DC power of a sufficient voltage and current for operating the circuitry for decoding PLC signals and driving one or more audio transducers.

Various forms of speakers may be utilized within the present invention, such as a powered low-range surround-sound speaker (woofer) 50, on up through middle-range and high-range speakers 52, 54. Convenient connection of the speakers to outlets alleviates the troublesome routing of wiring from an amplifier to speakers, which are disbursed in the room for optimal sound.

1.1.3 PLC-Ready DVD Recorder.

Playback and/or recording devices which are PLC-ready (have an integrated PLC interface or to which a PLC interface module is operably coupled) may be controlled over the PLC network for receiving or transmitting video and/or audio streams. One such device is represented by DVD recorder 62 connected through power connection 64. DVD 62 is configured for recording a stream sent over power line 12, or for playing back a stream to a destination, for example to television 46 over the power line. Locating DVD unit 62 is straight-forward as it may be connected to any outlet on the home and need not even be highly accessible as it may be controlled by other devices connected to the PLC from which commands are sent to DVD 62 (or other playback and recording device). The user may plug DVD 62 or other media devices into any power outlet. A user can direct output from DVD 62 to either television 34, 46, and may allow audio (i.e. from a CD) to be played over speakers 50, 52 and 54. It will be appreciated that input for recording may be received over the PLC, from a wired connection, or alternately from other connection types.

Media devices supporting inherent remote control capability may be controlled utilizing their own remote control device, or a device capable of generating compatible command codes. Furthermore, media devices may receive operating commands over the PLC which have been generated in response to user commands, such as those received from a remote control unit, for example from remote control unit 32 being utilized in a separate room and directed through television 34 and server 14 to DVD 62 or through television 34 to DVD 62.

1.1.4 Video/still Camera.

Other video and audio devices may be connected to the PLC system of the invention. A video camera-recorder 66 is shown coupled to an AC adapter 68 from which it receives power and over which it communicates over the PLC network to other devices, for example server 14. It will be recognized that the communication connection established by the video camera-recorder 66 may comprise any desired transmission mechanism, for instance an IEEE 1394 port or analog audio/video ports which may be utilized to communicate audio and video streams. It should be appreciated that video camera-recorder 66 may record streams sent by server 14 or from other device sources such as cable or other high bandwidth inputs.

1.1.5 PLC-Ready AC Adapter.

An AC Adapter 68 is shown for electrical recharging of the battery within video/still camera-recorder 66 from power received from AC connection 70, while providing connectivity between the camera-recorder 66 and server 14. Communication connectivity between camera-recorder 66 and AC adapter 68 may comprise an IEEE 1394 standard connection, an Ethernet connection or other communication interface standard supported on video still camera-recorder 66. It should also be recognized that the PLC-ready AC adapter according to the present invention can be configured for connecting other generally portable devices to the PLC, such as personal data assistants, laptop computers, image printers, and so forth.

The AC adapter is generally configured for powering an electronic device which is unable to operate directly from AC line power. The AC adapter is configured for communicating data between an electronic device being powered by the AC adapter and devices coupled to the AC power-line; wherein the AC power line is to be utilized as a power-line communications network. The electronic device operating from the AC adapter is typically a portable device, although non-portable devices are often supported with an AC adapter that on legacy devices is generally utilized in combination with a non-PLC communication link.

The electronic device unable to directly operate from AC power may be selected from the group of electronic devices consisting essentially of still cameras, video cameras, personal digital assistants, cellular phones, laptop computers, audio recorders, audio players, printers, scanners, modems, routers, hubs, switches, telephones, wireless access points, and so forth.

1.1.6 PLC-Ready PC.

Another device that could be typically connected to the PLC network is one or more personal computers 72 shown operably connected through AC connection 74 with the PLC. PC 72 is shown incorporating a PLC interface through which it sends or receives IP-based data over the power line. Server 14 can operate as a network bridge, wherein it downloads data from the Internet which is sent from modem 18 to server 14, which forwards the data to PC 72 over the power line 12. Conversely, for uploading, server 14 receives data from PC 72 and forwards it to modem 18. Consequently, from television 46, the user can choose contents in PC 72, for example, an MP3 audio file, to decode at television 46.

1.2 Server.

A client-server model is generally adopted in the present invention so that coordination of device operation may be readily performed without complex interoperability issues arising. It should be appreciated, however, that any of the devices may operate as a server, or alternatively that they communicate directly with one another within the system without the need of a dedicated server.

1.2.1 Analog Inputs.

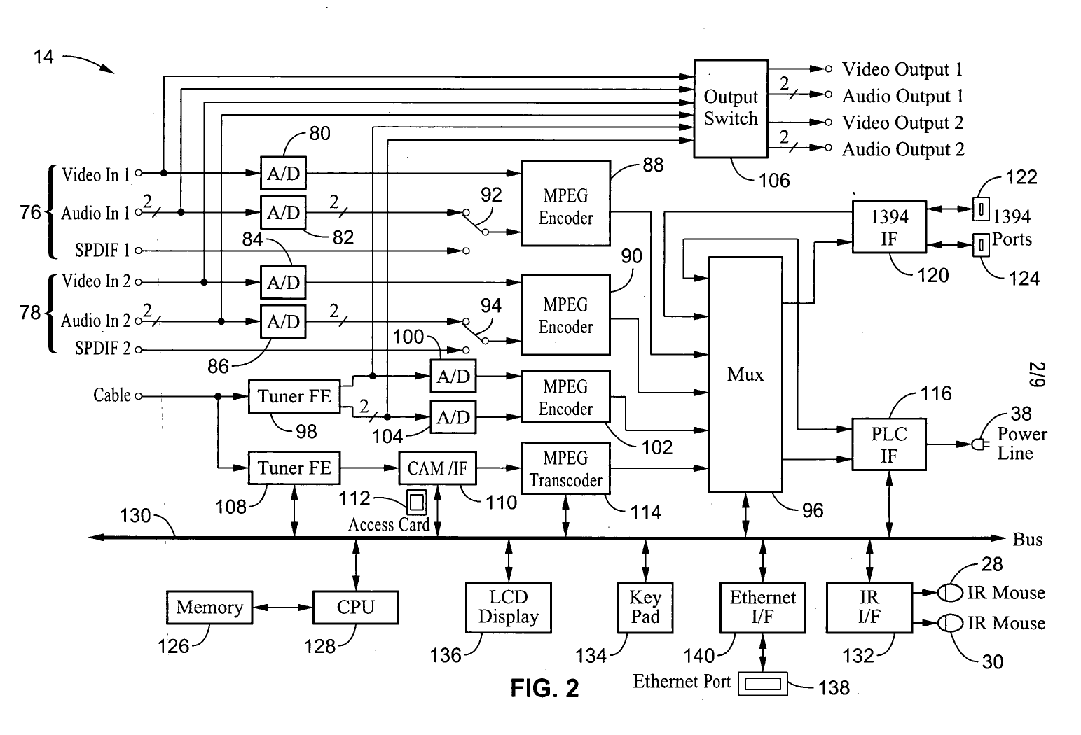

FIG. 2 exemplifies a model of server 14, however, it will be appreciated by one of ordinary skill in the art that server 14 may be implemented utilizing any of a number of different electronic design architectures, and may host a variety of features.

Streaming connections are depicted as input connections video-in, audio-in, and SPDIF™ inputs. One or more video and/or audio channels may be supported, with the embodiment shown with two sets of input connectors 76, 78. The video and audio inputs within these groups provide analog input for use with legacy analog devices, such as DVD player 24 and VCR device 26. The SPDIF connection provides a digital connection (SPDIF being the “Sony Philips Digital I/F” as defined in IEC60958 specification).

The analog signals are encoded within A/D converters 80, 82, 84, 86 prior to MPEG processing. For example, analog NTSC video signals received from video one are analog-digital converted in A/D 80 and then MPEG encoded in MPEG encoder 88. Analog audio signals from audio one are analog-digital converted in A/D 82 and MPEG encoded in MPEG Encoder 88. Similarly, channel two video and audio signal are encoded in A/D converters 84, 86 and processed in MPEG encoder 90. Switch 92 allows connecting A/D 82 with MPEG encoder 88, these signals marked with a slash two (“2/”) on the line indicate these as stereo signals.

When a digital input signal is received from SPDIF instead of the analog signals, switches 92, 94 directly connect SPDIF inputs to the respective MPEG encoder which multiplexes the encoded audio and video signals to output a stream to multiplexer 96.

1.2.2 Tuner/Front-end Blocks.

An analog cable signal is tuned and demodulated in tuner/front-end 98, the output from which is analog-digital converted in A/D 100 and MPEG encoded in MPEG encoder 102. Similarly, the audio output from tuner/front-end 98 is analog-digital converted in A/D 104 and MPEG encoded in MPEG encoder 102 which is sent to multiplexer 96.

Output switch 106 is implemented to switch analog audio/video output signals for recording, such as to VCR 26, or other analog recording/display devices. Output switch 106 preferably receives three pairs of analog audio/video signals from the two analog input ports and analog tuner/front-end 98. One of three inputs is selected for each of the two analog audio/video output ports (Audio/Video Out 1, 2) under program control.

A digital cable signal is tuned and demodulated in tuner/front-end 108, whose output signal, which is encrypted for content protection, is decrypted in conditional access module (CAM) interface 110. CAM interface 110 preferably decrypts the stream in cooperation with an access card 112. The decrypted stream is transcoded to another rate in MPEG transcoder 114 and sent to multiplexer 96.

1.2.3 Multiplexer and PLC Interface.

Multiplexer 96 operates to multiplex the input streams and couples the result to PLC Interface 116 which sends the streams to the power line through power plug 38, or a 1394 interface 120 which sends the streams through IEEE 1394 ports 122, 124.

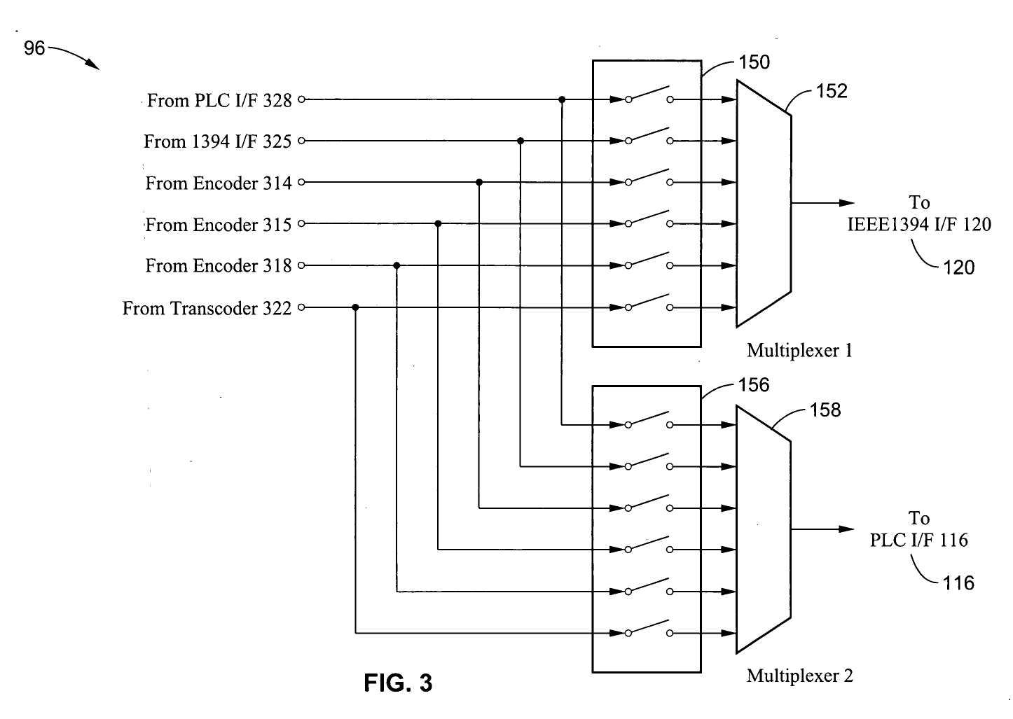

FIG. 3 shows multiplexer unit 96 in greater detail, with switch array 150 selects signals to send from the six inputs. The selected signals are multiplexed to a stream in multiplexer 152 and sent to IEEE1394 I/F 120. Similarly, switch array 156 selects signals for multiplexer 158, whose multiplexed output is sent to PLC interface 116.

1.2.4 IEEE 1394 Interface.

IEEE 1394 Interface 120 receives a stream from HDD 20 over IEEE 1394 bus 22, such as utilizing IEEE 1394 port 122 for this purpose. The stream is sent to multiplexer 96 for PLC transmission. Another stream output from mutiplexer 96 is sent to IEEE 1394 interface 120. IEEE 1394 interface 120 transmits a stream to HDD 20 over IEEE1394 bus 22. It should be appreciated that both the input and the output ports of IEEE1394 Interface I/F may be used at the same time. For example, a stream may be transmitted from tuner/front-end 98 and sent to HDD 20 through IEEE1394 bus 22, while simultaneously a playback stream from HDD 20 is received by multiplexer 96. The playback stream may be sent to power line 12 through PLC Interface 116, such as when the system is operating in a “Live Pause” (delayed playback) mode.

1.2.5 CPU and Other Blocks.

Control software within memory 126 is executed by CPU 128 for controlling system blocks through internal bus 130. Additional other blocks are shown connected to bus 130, and it should be appreciated that various interfacing and auxiliary functionality may be supported over bus 130.

IR (infrared) interface 132, coupled with IR mouse 28, 30 is implemented to control a legacy analog device, such as DVD player 24 and/or VCR 26. Legacy devices, such as these, are typically configured with an IR interface to receive IR commands from a handheld IR remote control device. In a conventional media environment a legacy video device would need to be connected to each television wanting to view content generated from a legacy device. However, it should be recognized that within the present system a legacy device can be connected in a remote location that does not need to be adjacent to any of the television sets over which content is to be directed, and need not be adjacent to any input device from which content will be recorded. As each IR device vendor generally utilizes a proprietary command format, the server of the present system is configured for generating IR output on IR mouse 28, 30, in any desired command format.

In a similar manner, selected IR commands received through television 34, or other devices, which are transmitted over the PLC network to server 14 are interpreted based on the command setting for the manufacturer, or registered through a command learning mode process.

Consider this scenario wherein a user desires to display content upon television 34, which is located in the family room, from VCR 26 which is located in the master bedroom. Referring to FIG. 1, the user enters commands on handheld remote control 32 for controlling operations of the VCR (or a particular VCR if more than one are located in the network). In this aspect of the invention the command parsing routines, or other programming within the television set (or other remotely controlled device), recognizes that the command does not match commands directed at the television set itself and thereby passes the commands through to the communication channel, which in this case is the PLC network. By passing through commands unknown to the television control circuits, functionality can be added to the network and controlled by a remote control device, without the need to update the software of the television (or other IR-equipped device which receives the commands).

The commands forwarded over PLC network are received by a device that can act on the commands. Preferably, a server 14 receives the commands over a PLC interface 116, with the commands being processed by CPU 128 in combination with memory 126. After interpreting the commands, CPU 128 sends control signals to IR mouse 30 which modulates its IR output intensity to control playback, recording, fast-forward, rewind, pausing, and so forth of VCR 26.

Less preferably, operating commands may be received by a server configured with a wireless receiver (optionally a transceiver) from a wireless remote control device. In this configuration, the devices coupled to the PLC network need not be configured for passing commands through their infrared interface and on toward the server. It will be appreciated that wireless connectivity over a distance equivalent to that within a given residential setting may be readily achieved. Using wireless connectivity, it would be preferable that the media devices coupled to the PLC network are configured to receive operating commands from the server, wherein the user could rely solely on utilizing the wireless remote for controlling operations, including typically local commands such as muting, volume, and so forth. It should also be recognized that wireless remote controls may be configured for communicating over specific channels wherein the operation of multiple remote controls could be supported within a given local environment.

PLC Interface 116 is preferably configured with encryption and decryption capability, wherein data remains secure despite multiple virtual networks sharing the same PLC network segment (i.e. last power distribution leg from distribution transformer to homes). It is preferable that all PLC interface units within the system utilize compatible encryptor and decryptor circuits.

Server 14 has a common key for the virtual network. When connecting a new device to the power line network 12, the user inputs its unique ID number to server 14. Server 14 encrypts the common key with the unique ID number which is sent to the new client. The client decrypts the number and obtains the common key. All communications in the virtual network are encrypted with the common key. Without knowing the common key, any device cannot communicate with another device in the network.

Keypad 134 transmits input data to CPU 128 through bus 130 for controlling server operations, modes, and features.

LCD display 136 provides for the display of system control aspects, such as the display of tuning status, network status, active AV ports, error messages, and so forth. Preferably, the display is coupled to a device, such as a server, and configured to display overall system information although it could be implemented as a separate monitor circuit and/or coupled to any one or more device.

Cable/phone line modem 18 of FIG. 1, by way of example and not of limitation, may be connected to Ethernet port connection 138 coupled to Ethernet interface 140 of FIG. 2. Data from modem 18 is routed to CPU 128 and processed. If necessary, CPU 128 directly sends the data to IEEE1394 I/F to store in HDD 20 of FIG. 1. A bridging mode can be entered in which audio/video streams or data from one source may be routed by the server to another recipient. For example, streaming data received from modem 18 may be directly transmitted through PLC I/F 116 to a client, such as PC 72 over power line network 12. For uploading, data from PC 72 is received in PLC Interface 116 and sent to modem 18 through Ethernet interface 140 and Ethernet connection 138. In these operations, data is sent directly between PLC I/F 116 and Ethernet interface 140 using DMA (Direct Memory Access) mechanism controlled by CPU 128.

1.3 Client Television.

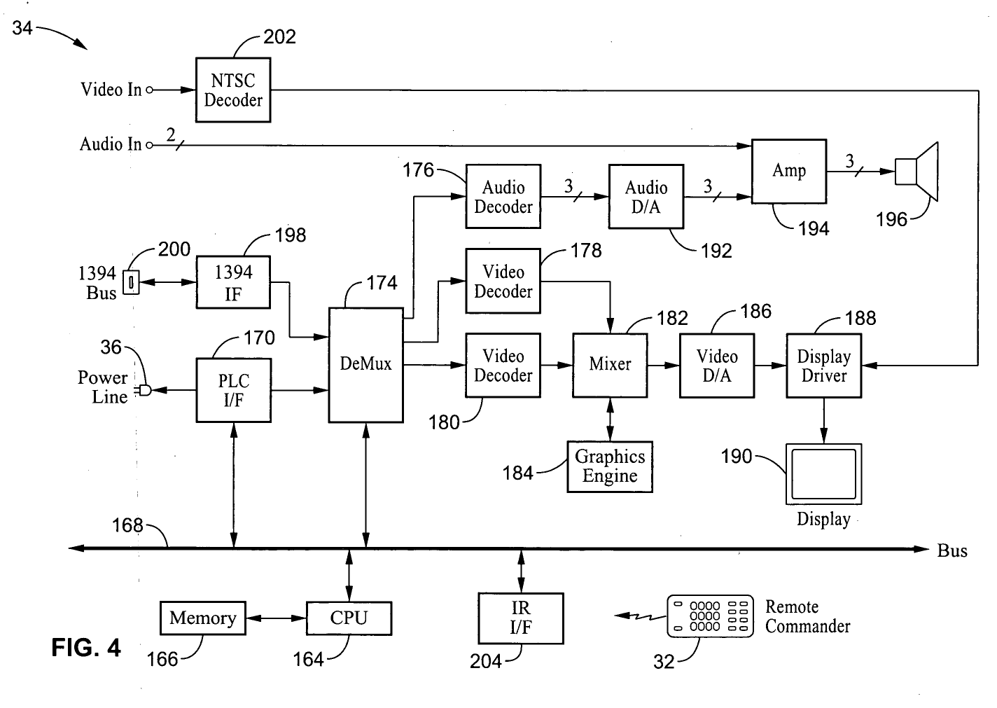

FIG. 4 exemplifies a device, in this scenario a television 34, configured according to aspects of the present invention. Control of television operation is controlled by a control circuit, herein exemplified as a CPU 164 in combination with memory 166 which pass data and control information to subsystems over bus 168. It will be appreciated that a number of alternative architectures may be adopted for controlling subsystems within a device, such as a television without departing from the teachings herein.

PLC interface 170 receives streams and control signals from power plug 36 connected to the power line, such as shown by power line 12 in FIG. 1. The output from PLC interface 170 is demultiplexed by a demultiplexer 174 and coupled to audio decoder 176 and video decoder 178. If the received content contains a second stream of video data for picture-in-picture (PinP), then the second stream is coupled to video decoder 180. In mixer 182, the decoded video signals from video decoder 178 and video decoder 180 (if available) are mixed with graphics, such as data generated in a graphics engine 184 which is then converted to analog video by a video D/A 186, with the output sent through a display driver 188 for display on video display element 190. It should be recognized that PinP can be utilized not only to watch two TV or video programs, but also to monitor images from the remote camera while watching a TV or video program, and so forth.

Audio streams received over the PLC are decoded within an audio decoder 176 whose output is converted to analog by audio D/A 192, amplified in an amplifier 194 and sent to speaker 196. It is preferable that the audio portion be configured for supporting as least three channels of audio (i.e. front-left, front-center, and front-right).

Television 34 is preferably configured for communicating over other interfaces, such as an IEEE 1394 interface 198 coupled to connection 200. An audio/video stream received over the IEEE 1394 interface 198 is passed to demultiplexer 174 and processed in the same manner as a stream emanating from the power line. CPU 164 can communicate asynchronous data (i.e. a control command) back to the content sourcing device through the IEEE 1394 bus, or alternatively the PLC network, depending on how the device is connected in the system. As previously described video and/or audio signals to device 34 (television) can be received from the power line on which the PLC network is established or over alternative interfaces, such as the IEEE 1394.

Analog video/audio input ports provide connectivity for legacy analog based devices, for example, game machines, video cameras, VCRs and so forth. An NTSC decoder 202 decodes the video input signal which is coupled to display driver 188 for output on display 190. A received analog audio signal is directed to audio amplifier 194.

CPU 164 exchanges asynchronous data (commands, data, etc.) over the PLC network with CPU 128 within server 14 of FIG. 2. CPU 164 executes programming, such as stored in memory 166, to control device operations.

An IR interface 204 connected to local bus 168 is configured for registering commands from an infrared remote control unit 32 (FIG. 1), although it will be appreciated that the interface and remote control may communicate by alternative means, such as wirelessly, without departing from the teachings of the present invention.

It should be recognized that other media devices configured for being controlled by a server over the PLC network, or less preferably with an IEEE 1394 or similar network connection, may be implemented in a similar manner as the television device shown in FIG. 4, albeit adapted to support the particular input or output.

1.4 Client Speakers.

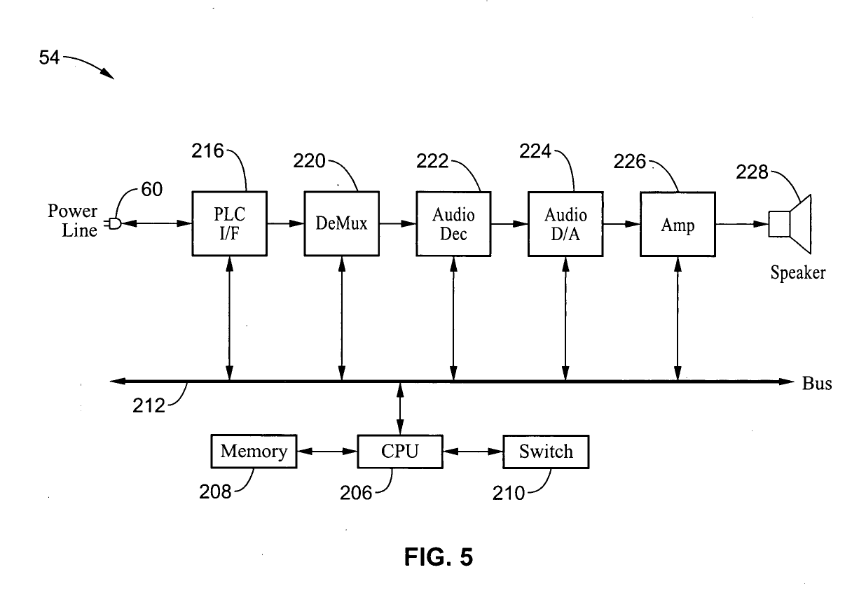

FIG. 5 exemplifies a device embodiment according to the present invention shown for generating audio output in response to audio streams received over a PLC network connection in the power connection of the device. Although shown for outputting a single audio channel, such as for speaker unit 50, 52, or 54, the device may be configured for outputting a number of channels of audio.

Operation of PLC speaker unit 54 is preferably controlled by a CPU 206 in combination with programming executed from memory 208 over an internal bus 212. An optional switch 210, or other form of user selector, may be provided to allow selecting which channel of audio is to be decoded by the unit.

Audio information is received encoded within the AC power from connection 60 into PLC interface 216, whose output signal is demultiplexed in demultiplexer 220 and decoded in audio decoder 222, which preferably decodes a single channel based on the setting of switch 210. The user selects a channel to be decoded, such as from the three of rear-right, rear-left and woofer. For example, suppose that surround speaker 54 is a rear left speaker, wherein switch 210 is set for rear left so that audio decoder 222 only decodes the rear left channel. The decoded signal is digital-analog converted in audio D/A 224, amplified in amplifier 226 and sent to loudspeaker 228.

It should be appreciated that although the audio transducer 228 has been shown configured for receiving analog input, it may be configured to receive digital inputs, wherein audio D/A 224 and analog amplifier 226 can be replaced with a class-D amplifier, or similar digital audio output.

CPU 206 controls the operation of demultiplexer 220 and audio decoder 222 in response to the switch setting, or other form of selection input. In addition, CPU 206 controls the amplifier stage, allowing parameters to be adjusted such as volume, and optionally other metrics such as tone, base, and so forth. The volume attenuator and the tone filter are preferably included in audio decoder 222 or audio D/A 224. CPU 206 communicates with CPU 128 within the server by exchanging asynchronous data (commands, data, etc.) through PLC interface 216 that connects to PLC network 12 as shown in FIG. 1.

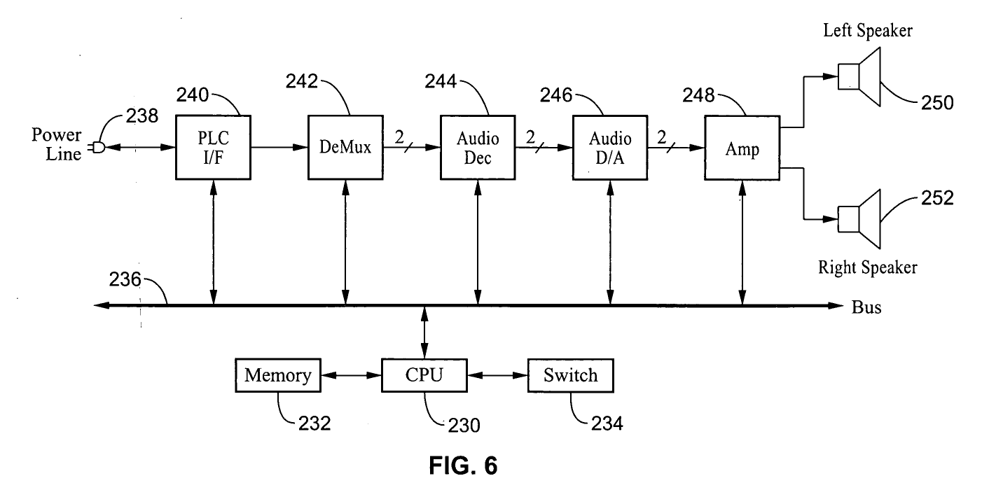

FIG. 6 exemplifies another form of audio decoding, wherein two audio channels are decoded, such as for driving the rear speakers. The preferred architecture is similar to that of FIG. 5, wherein blocks 230 through 248 generally correspond to the blocks 206 through 226. Demultiplexer 242, audio decoder 244, and audio D/A 246, however, are configured for decoding two channels from the PLC network wherein amplifier 248 generates audio signals to drive a left speaker 250 and the right speaker 252. The speakers may be connected to the decoding unit with a speaker cable (or other audio connection), or the decoding unit may be integrated within one speaker unit and provide a connection for coupling the second speaker unit.

1.5 Client DVD Recorder.

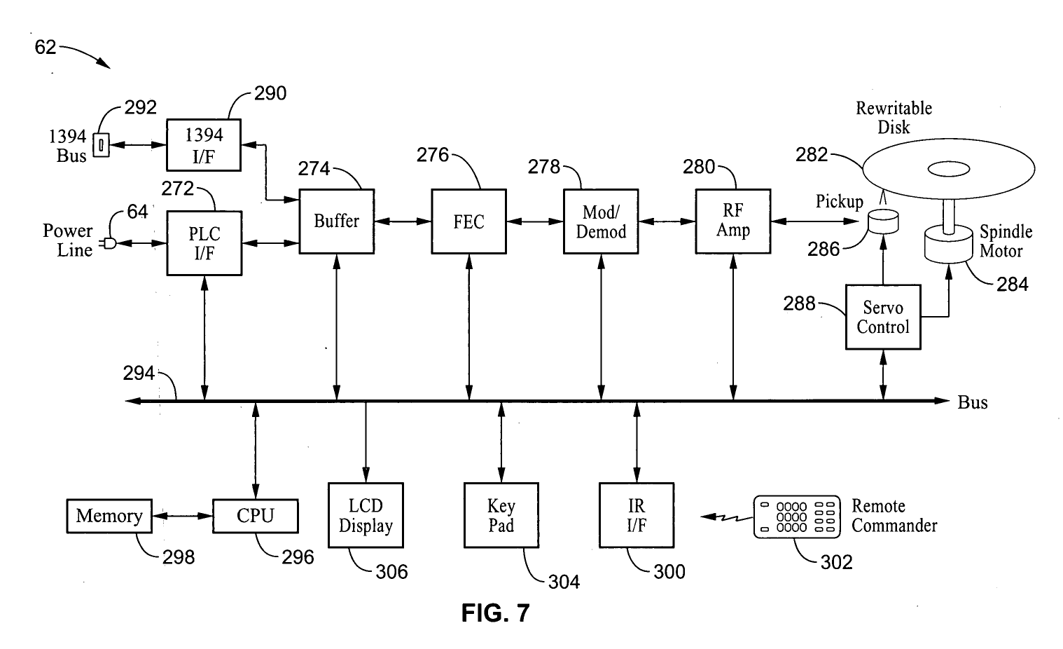

FIG. 7 illustrates an implementation of PLC-ready DVD recorder 62, which is configured without conventional analog audio/video interface. Power and signal for the DVD recorder are preferably obtained by making a single power outlet connection. As the DVD recorder can be controlled over the PLC network it may be connected to any location within the virtual PLC network, for example it can be connected in the master bedroom with television 46 as shown in FIG. 1, yet be accessed from anywhere in the residence.

In record mode, the power line connection 64 is coupled to a PLC interface 272 which extracts the signal from the power in response to a record operation, or can encode a signal onto the PLC when in playback mode. In record mode, the output of PLC I/F 272 is buffered in buffer 274 and passed to forward error correction block 276, wherein an error correction code is added to the output signal from buffer 274. The result is modulated in modulator/demodulator 278, amplified in RF amplifier 280 and recorded on rewritable digital video disc 282, rotated by spindle motor 284, and accessed by pickup head 286. Servo control block 288 controls pickup head 286 and spindle motor 284.

In playback mode, the signal is processed in the reverse direction, with data on preferably rewritable DVD 282 being read by pickup head 286 and amplified in RF amplifier 280. The result is demodulated in modulator/demodulator 278, error-corrected in FEC 276, buffered in buffer 274, received by PLC Interface 272 for communication out over power plug 64.

Another interface is shown optionally connected in parallel to the power line interface. By way of example an IEEE 1394 interface 290 is shown connecting to port 292 which may be directly connected to another media device.

The video recording and playback functions are preferably controlled over a local bus 294 by CPU 296 in combination with memory 298. IR interface 300 is configured for receiving commands from remote control unit 302. Commands are received by CPU 296 for processing and control of DVD functionality, while commands may be similarly received over the PLC interface 272 for processing by CPU 296. A user interface is exemplified by keypad 304 in combination with LCD display 306, or other user interface controls, the information from which are received by CPU 296 over bus 294. The display can convey control information to the user such as current operation, track number, remaining time, volume name, error messages, and so forth. The information is also sent as asynchronous data to the control device, for example, television 46 over the power line 12 and displayed on the screen using the OSD (on screen display) function. CPU 296 can communicate with the CPU in television 46 by exchanging asynchronous data (commands, data, etc.), over the PLC network, or other interface connection, such as an IEEE 1394 bus.

1.6 PLC-Ready AC Adapter For Video Camera Recorder.

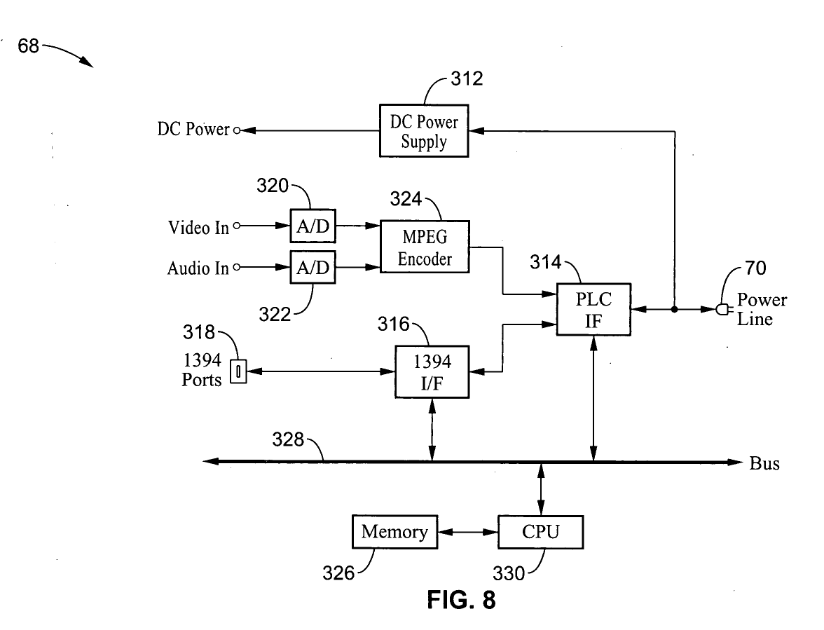

FIG. 8 illustrates AC Adapter 68 of FIG. 1, which connects to the power line through AC plug 70 that is coupled to a DC power supply 312 for providing DC operating power to a connected device, such as video camera-recorder 66 shown in FIG. 1. AC plug 70 is also coupled to PLC interface 314 which is coupled to a device communications interface, exemplified as a an IEEE 1394 interface 316 and IEEE 1394 connection port 318, and an analog audio/video interface comprising A/D converters 320, 322 and MPEG encoder 324.

By way of example an IEEE 1394 stream may be received from video camera-recorder 66 through IEEE 1394 interface 316, which is preferably bi-directional, and sent to PLC interface 314 which communicates the stream to a desired destination over the PLC network, for example client television 46. Bi-directional IEEE 1394 interface 316 can also receive a stream from a source, such as server 14 (FIG. 1), over the power line and communicate this stream (or one or more commands) to the attached device, such as video camera-recorder 66 for recording. The analog audio/video ports are provided for coupling to legacy analog devices, such as video camcorders with analog interfaces. In the case of legacy devices, the analog audio and video signals from the video camera-recorder 66 are analog-digital converted in A/D 320, 322 and then MPEG encoded in MPEG encoder 324 with the MPEG stream being sent to a destination, such as television 46, television 34, DVD recorder 62, VCR 26 over server 14, the hard disk drive 20 over server 14, or to any other device connected to the PLC network which is configured for receiving that type of data stream. It should be appreciated that, although not shown both analog audio and video may be supported as well.

The functions within AC adapter 68 are controlled over bus 328 by CPU 330 in combination with memory 326 from which control programming is executed and operating data is stored.

As a variation, AC Adapter 68 may be a cradle for battery charging such that by placing video camera-recorder 66 on the cradle, all communication ports are automatically connected through the AC adapter to the PLC network, allowing the user to play or record using data using PLC network data.

1.7 PLC Interface For A Legacy Television.

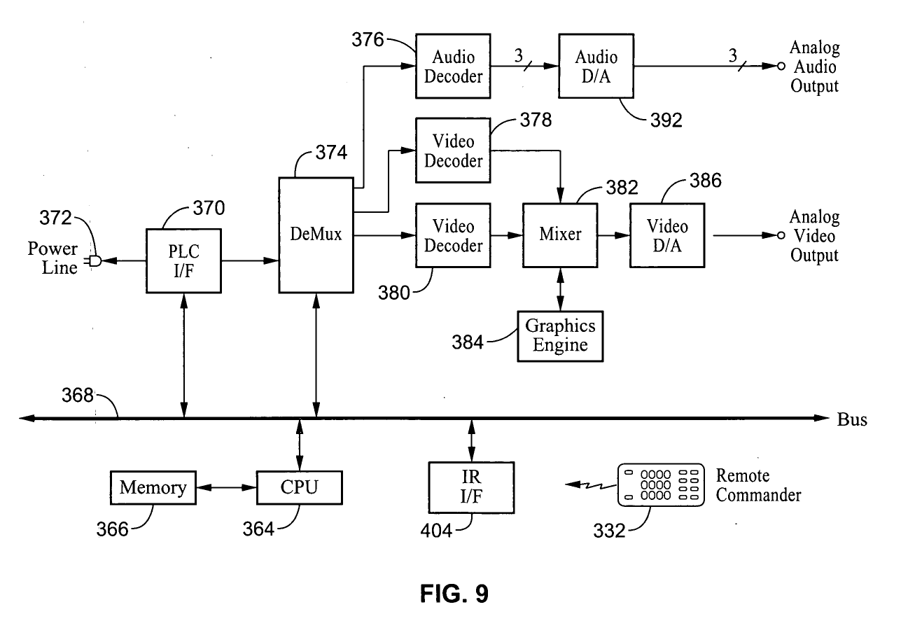

FIG. 9 illustrates a PLC interface to connect a legacy television to the power line network 12 (not shown in FIG. 1). The blocks in FIG. 9 are generally shown as comprising a subset of components depicted in television 34 of FIG. 4. The legacy interface comprises a CPU 364 which operates in combination with memory 366 and communicates streams and data over bus 368. A PLC interface 370 is shown with power plug 372. The output from PLC interface 370 is demultiplexed by demultiplexer 374 and coupled to audio decoder 376 and video decoder 378. Audio is converted by a D/A converter 392 for connection to the analog audio input of the legacy television. If the received content contains a second stream of video data for picture-in-picture (PinP), then the second stream is coupled to video decoder 380. In mixer 382, the decoded video signals from video decoder 378 and video decoder 380 (if available) are mixed with graphics, such as data generated in a graphics engine 384 which is then converted to analog video by a video D/A 386 for connection to the analog video input of the legacy television.

It is of particular note that FIG. 9 includes the use of an analog video and audio interface, wherein the interface allows communicating audio and video streams over the power line to a legacy television having analog audio and video inputs.

Remote unit 332 is preferably programmable which allows it to send commands to both the PLC interface and the legacy television. Commands specific to the television, such as power on/off command and volume up/down commands are sent to the television, and other commands, such as for controlling content, for example content channel control commands (i.e. up/down and select), are sent to the PLC interface. A preferred implementation of remote unit 332 can be programmed by the users to handle the multiple (i.e. two) command sets, wherein the user does not need to utilize multiple remote control units.

2. New Functions and Features.

2.1 Source and Device Selection.

2.1.1 Source Selection.

It is preferred that all devices connected within a given virtual power-line communication network are detected by a server, and/or other devices, using UPnP mechanisms, specifications for which may be found at the web site www.upnp.org, teachings of which are incorporated herein.

Assume that the user watches television 34 and utilizes remote control 32 for controlling content as well as video and audio parameters. It will be appreciated that the following content sources are available for display on television 34: cable television input, cable or phone line (Internet access), HDD 20, DVD 24, VCR 26, DVD recorder 62, video camera-recorder 66 coupled to AC adapter 68, personal computer (PC) 72, or other devices which can be coupled to the PLC network and which transmit data for receipt by the television.

A list of content sources can be displayed on television 34 allowing the user to select a content source and control access to it, by utilizing the remote control unit 32. The software of television 34 is preferably configured to display the source list. Alternatively, server 14 manages the items connected to the PLC network, generates the list of content sources, and intercepts and processes commands from remote control 32, which are not directed to television 34. Television 34 recognizes the devices connected to the PLC network, but does not inherently recognize what is connected to each of the devices. For example, television 34 would not detect DVD player 24, VCR 26 and HDD 22. Server 14 preferably sends peripheral device information to television 34. Accordingly, if the user enters a specific analog device name and a video port number to server 14, television 34 can get the device name and display it on the screen, otherwise the video port number (Video 1, 2, etc.) would be shown.

It should be appreciated that the graphics interface may be configured to be similar to that of a personal computer, such as displaying clickable icons for sources, wherein the source is selected in response to a user click (double click, or other selection function). If a list of content (programming) exists for a given source, then it is sent to the client device, such as television 34, in response to selecting that content source. The user can then select audio/video programming or a file from the list of content. It should be recognized that the user may select signal sources and contents as if these sources were directly connected to the television.

2.1.2 Speaker Selection.

The system allows the user to select which speakers are to be utilized for outputting the audio portion of source content, for example surround sound decoding may be selected with speaker 50, 52, 54 activated in conjunction with television 34.

2.1.3 Background Operation.

The user may control other devices through server 14, while watching a video program over television 34, or television 46. For example, the user watches a digital video cable program on television 34 while recording another analog video program on legacy VCR 26 coupled to server 14. In this example the cable channel being recorded as contained in the output signal from tuner/front-end 98 (FIG. 2) of server 14 is sent to legacy (NOT PLC-ready) VCR 26 as an analog output. Control signals for commanding legacy VCR 26 are communicated through IR mouse 30 which converts signals from server 14 into infrared commands in a format compatible with the original remote control device for VCR 26. If desired, the user can also monitor the stream recorded to VCR 26 on the display of television 34, or use that channel as a PinP source to the television.

2.1.4 Transparent Networks.

Server 14 has transparent bridging capability for IEEE 1394 bus 22 and Internet access through modem 18. Preferably all the networks are completely transparent to the user. Although HDD 20 is coupled over IEEE 1394 bus 22, the user can control it as if HDD 20 were on the same PLC network 12.

2.1.5 Storage Management.

Two or more storage devices may be connected onto the PLC network which may be handled as one large storage device, alleviating the user from monitoring storage levels and shifting content from one storage unit to another when remaining space on a storage unit becomes an issue. Client television 34 obtains available capacity from each available device on the network(s). When stream (program) length is already known, an appropriate storage device that has sufficient storage capacity is automatically chosen so that the stream is not split across multiple storage devices.

Although client television 34 may be configured to retain information about the location of programming, this is preferably contained on the media server. When the user unplugs a device, the information will be modified so that an unavailable program(s) or file(s) are indicated, such as marking those entries in the listing in red. In the case that a program being recorded is to be split across two or more storage devices, each device retains information on the subsequent storage device which retains the other portion of the programming. This next device information is communicated to television 34, wherein upon reaching the end of storage in the first recording device, television 34 can switch the source to record on the next storage device.

2.1.6 Access Rights.

Generally, the distributed media architecture over the PLC network allows any client on the PLC network to control any device on the network. For example, the user records a program to VCR 26 from client television 34, and may stop the recording from client television 46. However, the present system accommodates the situation in which the user does not want to allow control from another client, wherein the recording operation can be locked by the system. Locked operation can be controlled only from the original client, which in this case is television 46 through which remote control commands are received which are directed through the server to control VCR 26. The lock may also be controlled with a password, biometric identifier, or similar, for controlling the locking and the unlocking of device recording, or selected functionality in general. Controlling the lock with a password, or other access token, allows the original user to control the client from anywhere on the network.

2.2 Room-To-Room Live Pause.

As described previously, server 14 and HDD 20 are preferably configured with live pause capability, wherein a live program sent from the cable network is automatically stored on HDD 20 and played back with delay.

This configuration allows the user to pause the system at any time during watching the show, such as to answer a telephone call. The user can return to the system and continue watching the show where they left off by unpausing the system. Without live pause, the user would either miss a portion of their show, or would need to establish a recording schedule for the remainder of the show, which would in most cases be impractical as the user does not know how long they will be kept from their show. Live pause functionality within the system can be preferably accessed from any device on the PLC network, it can be made subject to lockout and other restrictions. For example, the user watches about the first half of a live televised event on television 34 and then moves to the bedroom and watches the rest of the program on television 46, which is allowed to control HDD 20. Optionally the user can select a locked mode which requires unlocking of live pause when attempts are made to access it from another device. By utilizing the live pause mode, the user does not miss any of the program stemming from answering the phone, moving room-to-room, or for other situations that have pulled them away from the television.

2.3 Audio Latency Adjustment.

It should be recognized that different devices on the PLC network may subject the stream being decoded to different temporal delays. For example, the decoding of video/audio by a first device, such as a television set, is subject to a first delay, while the decoding of audio by a second device, such as a PLC-ready speaker 50, is subject to a second delay.

The audio-video experience can be degraded in response to the differing decoding delays, for example consider the situation wherein the decoded video output on television 34 lags behind the audio decoded by surround speakers 50, 52, 54.

Imagine hearing the gunshot before seeing the trigger pulled on the screen, or seeing an explosion before the vehicle is seen to explode on the screen. Humans are more sensitive to the discrepancy of audio preceding video than they are to the converse synchronization problem. The latency of devices on the PLC network is therefore preferably adjusted by the present system to provide synchronization within the error range between forty five (45) milliseconds for audio leading video, up to one hundred twenty five (125) milliseconds when video leads audio. Typically, the decoding of audio can be adjusted, such as by including a delay, wherein display content is provided slightly before the audio content is output.

Similarly, encoding latency can be adjusted to prevent recording streams which are not synchronized. It is preferable that information about the latency for each media device and situation be provided by the manufacturer, although the present system describes determination of latency.

MPEG encoder 88, 90, 102 and MPEG transcoder 114 have the capability to send a test audio/video signal for latency adjustment. In latency adjustment mode, the MPEG encoder/transcoder alternately sends two test patterns. For example, a color bar and a gray scale are toggled every three seconds, with two audio test tones being synchronized with the video. For example, a color bar is sent with tone A and a gray scale is sent with tone B. Alternatively, instead of two tones, the encoder may send a short click at the moment the video patterns are toggled. The user chooses a speaker, or other device, to adjust and adjusts the delay (i.e. using remote control 32) between the audio with video until they are well synchronized. The latency adjustment command is received by television 34 for display on client television, or directly or via server 14. Within speaker 50, CPU 206 receives the command through PLC interface 216 (FIG. 5), and it preferably controls decoding delay time in audio decoder 222.

One method of changing the delay is by increasing or decreasing the buffering within audio decoder 222 based on latency adjustment command. One alternative method if PLC interface 216 or demultiplexer 220 has a buffer and latency adjustment capability is to allow CPU 206 to control the buffering instead of audio decoder 222. Other speakers, or devices, within the system can have their latency adjusted in a similar manner. Furthermore, video decoder 178,180 and audio decoder 176 within television 34 may have a similar latency adjustment capability so that the user can adjust audio or video decoding latency.

2.4 Rate Control.

Rate control capability within the present system allows devices to harmoniously share the PLC network bandwidth, while maximizing the use of available bandwidth. Referring again to FIG. 2, CPU 128 monitors power line conditions based on information from PLC Interface 116. If the power line network bandwidth is constrained in response to increased noise, or increased traffic, the CPU initiates rate control, such as for example asking each encoder to reduce the encoding rate. MPEG encoder 88, 90,102 and MPEG transcoder 114 are preferably configured with rate control capability, while additionally or alternatively, multiplexer 96 can be configured with rate control capability. Rate reduction can be performed without any transmission interruption and the decoded video is gracefully degraded in response to adverse conditions which limit available bandwidth.

Regarding rate assignment, the system is preferably configured to allow the user to prioritize sources and destinations. For example, when digital cable source is transcoded by MPEG transcoder 114 and communicated through IEEE 1394 interface 122 to HDD 20, the user may give higher priority (i.e. larger percentage of the bandwidth), to the digital cable source to assure a high quality recording. Initial values for each of four sources (analog 1, 2, analog cable and digital cable) may be set to a desired default, such as each receiving 25% of the available bandwidth. The user may over-ride the default allotments in any desired manner, for example allotting 40% to the digital cable source, while the other sources share the remaining 60%, that is 20% each. In another example, the user may want to direct more bandwidth to viewing HDTV on the large screen of television 34, and thereby assign a higher priority to any stream that comes to television 34. All these assignments can be performed from television 34 using a remote control device, such as a handheld IR remote control.

Server 14 may be configured to down-convert an HD (high definition) stream to SD (standard definition) stream when PLC network conditions deteriorate. However, since HD-SD switching is noticeable, server 14 preferably monitors and makes decisions based on the network condition over a period of time thereby preventing frequent HD-SD switching.

2.5 Parental Control.

Parental control can be an important system feature because otherwise a client television can access any content located over the PLC network, including output from recorded content, cable boxes, and so forth. Parental control features allow a parent to set restrictions on content distribution over the PLC network. Restriction may be based on a number of different criterion, an example of those criterion is shown in the following list.
source (analog video 1, 2, analog cable, digital cable, etc.);
program channel number (i.e. setting allowed channels {Disney} and excluded channels {HBO, MAX});
program rating (i.e. up to PG13);
time (i.e. only from 6pm to 8pm).

The user sets these restriction configurations and a password (or other access token) from any of the devices, such as from television 34 using remote control 32, with the setting stored on server 14. A password must be entered to access content when a request is made for a controlled stream. Additionally, or alternatively, the content blocking may be performed at clients of the system, wherein the client receives the stream but does not decode it until the right password is entered. In either case the user is prevented from accessing the content without entering a correct password. It will be appreciated that other access limiting tokens, such as biometric scan, and so forth may be substituted for the password in all descriptions herein.

The system is preferably configured to allow the user to completely prohibit any access to a device without a correct password being entered. For example, without correct password entry, the system can prevent anyone from writing to or reading from HDD 20. This access limitation can be very beneficial to control erasure of important content from storage devices.

The system also preferably supports a password hierarchy, wherein different levels of access can be accorded different passwords. For example a parent may establish two control levels with a parent-only password to gain access to any content, and a second password to a mid-teen daughter for gaining access to PG-13 content, access to which remains prohibited for her seven year old sister.

2.6 Picture In Picture (PinP).

A client television, such as television 34 (FIG. 1), may simultaneously receive multiple (i.e. two) independent audio/video streams for performing picture-in-picture (PinP) functionality. The video stream for the smaller picture is decimated to fit the size of the small “in-picture” area of the screen. To conserve network bandwidth, television 34 may direct server 14 to communicate the second stream at a low rate or formatted at low resolution for display within a small screen area. The small screen size may be, for example, CIF (Common Interface Format, 352 by 288 pixels) or QCIF (Quarter CIF, 176 by 144 pixels). In response to the user selecting to swap the pictures, the television asks server 14 to change the rate or the picture size to the original and begins decoding the stream to full-size pictures.

2.7 IR Mouse.

Typically, each device vendor employs proprietary IR command codes within its IR command sets for handheld remote controls. In order for the server to properly interpret commands received through other devices, or to control legacy devices connected to the server with IR mice, the user needs to either specify sufficient vendor information, wherein parameters may be retrieved about the command set, or the command set must be learned through executing a learning mode.

2.8 IEEE 1394 Server-Client Connection.

An IEEE 1394 cable may be utilized for connecting server 14 and client television 34. This solution may be most appropriate when server 14 and client television 34 positioned close to one another and/or when the user wants to conserve PLC bandwidth, by directing communication between one or more devices to another link. For example, multiplexed streams can be sent through multiplexer 96 over the IEEE 1394 connection to demultiplexer 174 in a client television (FIG. 4) over the IEEE 1394. It should be recognized that the IEEE 1394 bus is a noise-free, completely isolated isochronous bus, wherein all streams could be sent to client television 34 without degradation. Simultaneously, server 14 may send another multiplexed stream to a device over the PLC network 12. Regardless of whether stream communication occurs over the PLC network, IEEE 1394 bus, or other communication link, the user operates the system in the same general manner from a client television.

2.9 Multiple Servers on the PLC Network.

The user may connect multiple servers within a given virtual power-line, such as a second server, a third server, and so forth. The second or the third server can also be controlled from client television 34, or other clients of server 14 and the PLC network. As described above, each server provides peripheral device information to the client. The user can easily select a device connected to a server.

3. Isolation of Virtual PLC Networks.

It will be appreciated that a number of homes or business offices may share a single distribution transformer, wherein the available power-line bandwidth is shared across a number of homes. Problems arise from this situation, including limited available bandwidth, and unfair bandwidth allocations.

One preferred solution to remedy the problem is through the use of a blocking filter, such as may be installed within the breaker panel of the home, or business. The filter operates to block noise and signals from neighboring virtual networks sharing the same physical network while it also reduces signal leakage within the virtual network. Utilizing a blocking filter allows the user to fully utilize the bandwidth of the power line without the need to share the bandwidth with neighbors.

Alternatively the bandwidth allocation issue (but not the availability of bandwidth) can be overcome by utilizing assigned time or bandwidth slotting, such as determined by a master device, to control the assignment of bandwidth across the network.

4. Alternatives.

It should be readily recognized that a number of alternatives can be implemented for the system described without departing from the teachings herein. In addition, the teachings of this invention are shown applied to a power-line network, but may be generally applied to other forms of networks without departing from the present invention. The following outlines a few of these alternatives, which are provided by way of example and not of limitation.

The server (i.e. server 14) may incorporate an MPEG decoder to allow sending a digital stream to a legacy analog device, (i.e. VCR 26 of FIG. 1), or for a television providing only analog audio/video input.

Servers on the PLC network may contain a mass storage system, such as an internal hard disk drive, in addition to or as an alternative to HDD 20.

An audio device, such as a PLC-ready portable stereo (i.e. boom box), may be connected to the PLC network for accessing audio streams from the server which operates as an audio server. As another example a CD/MP3 player can be connected to the server for communicating data between the CD/MP3 player and any device on the virtual PLC network, such as downloading content from HDD 20, uploading CD/MP3 content from the portable device into the system.

A wireless bridge can be supported within the present system, for example, an 802.11a/b bridge may be connected to the PLC network. As the other networks, the wireless network is completely transparent allowing the client to access a device on the wireless network as if the device were on the PLC network.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus for controlling video and audio components distributed over a power-line communications (PLC) network, comprising:
a server configured for controlling the communication of video and audio streams between media devices connected for communicating over said power-line communications (PLC) network; and
means for interpreting commands, received from a user through at least one of said media devices and communicated to said server, and controlling the communication of media content to and/or from said media devices and said server in response thereto.

2. An apparatus for controlling video and audio components distributed over a power-line communications (PLC) network, comprising:
a server configured for controlling the communication of video and audio streams between media devices connected for communicating over said power-line communications (PLC) network;
a power-line communications (PLC) interface coupled to said server for communicating with remote media devices connected over said power-line communications (PLC) network; and
programming associated with said server interface for,
interpreting command codes received over said power-line communications (PLC) network;
controlling the operation of said media devices connected over said power-line communications (PLC) network in response to command codes received and interpreted by said server which were received over said power-line communications (PLC) network.

3. An apparatus as recited in claim 2, wherein said server operates as a media server and media devices configured for communicating with said server over said power-line communications network operate as clients of said server according to a client-server model.

4. An apparatus as recited in claim 2, further comprising at least one media device configured for receiving commands from said server and for receiving and/or transmitting media content over said power-line communications (PLC) network to or from said server.

5. An apparatus as recited in claim 4, wherein said media device is configured for responding to commands received from a remote control unit.

6. An apparatus as recited in claim 5, wherein said remote control unit utilizes infrared signals to communication with said media device.

7. An apparatus as recited in claim 5, wherein said media device is configured for communicating selected commands, received from said remote control unit, to said server.

8. An apparatus as recited in claim 4, wherein said media device may be selected from the group of media devices consisting essentially of television sets, video monitors, audio systems, surround sound systems, speakers, computer devices, personal computers, video and/or audio recording units, video and/or audio playback units, still image capture or playback units, and AC adapters configured for communicating with a media device coupled to said AC adapter.

9. An apparatus as recited in claim 2, further comprising means for encrypting and decrypting data communications between said server and said media devices over said power-line communications (PLC) network.

10. An apparatus as recited in claim 2, wherein said server is configured for receiving video and/or audio content from a content source.

11. An apparatus as recited in claim 11, wherein said content source may be selected fioro the group of content sources selected from cable connections, satellite feeds, broadcasting antennas, or content playback devices.

12. An apparatus as recited in claim 2, further comprising a media storage element connected to said server for the storage of video and/or audio content received from devices over said power-line communications (PLC) network, and/or for the retrieval of video and/or audio content for output from devices over said power-line communications (PLC) network.

13. An apparatus as recited in claim 12, wherein said media storage element comprises a hard disk drive.

14. An apparatus as recited in claim 13, wherein said hard disk drive is incorporated within said server.

15. An apparatus as recited in claim 13, wherein said hard disk drive is external to said server and coupled to said server by a communications link.

16. An apparatus as recited in claim 15, wherein said communication link coupling said hard disk drive to said server comprises an IEEE 1394 interface.

17. An apparatus as recited in claim 2, further comprising means for isolating a virtual network portion of said power-line communications network from other virtual network portions sharing a single physical power line distribution transformer.

18. An apparatus as recited in claim 17, wherein said means for isolating said virtual network portion comprises a blocking filter connected to the power line for isolating portions of said physical power-line from one another.

19. An apparatus as recited in claim 2, wherein select remote control operating commands, which are not utilized by said media device receiving the commands from the remote control unit, are routed to a server for controlling devices operably coupled to said server.

20. An apparatus as recited in claim 19, further comprising an infrared (IR) mouse connected to said server for converting commands from said server into infrared (IR) commands configured for being received and interpreted by a media device having an infrared (IR) control port.

21. An apparatus as recited in claim 20, wherein said server is configured for sending commands over said infrared (IR) mouse in combination with controlling the receipt or transmission of video and/or audio streams from said media device.

22. An apparatus as recited in claim 2, further comprising means for adjusting decoding latency between media devices connected to said power-line communications (PLC) network to synchronize output timing.

23. An apparatus as recited in claim 22, wherein said means for adjusting decoding latency is executed by said server for controlling decoding delay within said media devices configured for connection to said power-line communications network.

24. An apparatus as recited in claim 22, wherein said means for adjusting decoding latency comprises increasing or decreasing the buffering of streams for one or more devices to change the decoding delay.

25. An apparatus as recited in claim 2, further comprising means for live pausing of content being viewed, wherein after un-pausing play the programming can be viewed without loss.

26. An apparatus as recited in claim 25, wherein said means for live pausing stores content upon a storage device for delayed playback and while paused continues to store the programming for later resumption from the paused location.

27. An apparatus as recited in claim 2, further comprising means for controlling media access within said power-line communications (PLC) network.

28. An apparatus as recited in claim 27, wherein parental controls are established for limiting content access by viewing location, by password, or by biometric identifier.

29. An apparatus as recited in claim 28, wherein multiple levels of said content limits are established.

30. An apparatus as recited in claim 2, further comprising means for locking the operations of a first media device for which commands have been received from a second media device, said locking preventing media devices other than said second media device from altering the operations of said first media device.

31. An apparatus as recited in claim 30, wherein said means for locking may be bypassed utilizing a password or access token.

32. An apparatus as recited in claim 2, further comprising means for controlling the portion of said bandwidth to be utilized by a given media device configured for communication over said power-line communications network with said server.

33. An apparatus as recited in claim 32, further comprising means for prioritizing bandwidth utilization among media devices configured for communication over said power-line communications network.

34. An apparatus as recited in claim 2, further comprising means for communicating multiple video and/or audio streams to a given media device from said server.

35. An apparatus as recited in claim 34, wherein said multiple video and/or audio streams are communicated to a media device configured for displaying picture-in-picture.

36. An apparatus as recited in claim 2, further comprising an AC adapter configured for powering an electronic device unable to operate directly from AC line power.

37. An apparatus as recited in claim 36:
wherein said AC adapter is configured for communicating data between said electronic device and devices coupled to the AC power-line;
wherein said AC power line is to be utilized as a power-line communications network.

38. An apparatus as recited in claim 37, wherein said electronic device unable to operate directly from AC line power is a portable device.

39. An apparatus as recited in claim 37, wherein said electronic device unable to operate directly from AC line power is selected from the group of electronic devices consisting essentially of flat panel displays, still cameras, video cameras, personal digital assistants, cellular phones, laptop computers, audio recorders, audio players, printers, scanners, modems, routers, hubs, switches, telephones, and wireless access points.

40. An apparatus configured for being remotely controlled, comprising:
a media device configured for inputting or outputting video and/or audio streams;
a power-line communications interface coupled to said media device;
means for receiving control signals at said media device from a remote control unit; and
means for communicating at least a portion of said control signals, received at said media device, over said power-line communications (PLC) network for receipt by a remote media device.

41. An apparatus as recited in claim 40, wherein said remote media device comprises a media server configured for controlling the communication of media streams over said power-line communications (PLC) network.

42. An apparatus as recited in claim 41, wherein said media device coupled to said power-line communications network is configured for receiving media content input or transmitting media content output in response to commands received from said media server.

43. An apparatus as recited in claim 40, wherein said media device is selected from the group of media devices consisting essentially of video display devices, audio output devices, video recording devices, video playback devices, audio recording devices, audio playback devices, and combinations thereof.

44. An apparatus as recited in claim 40, wherein said media device comprises a television set.

45. An apparatus as recited in claim 40, wherein said means for receiving control signals comprises an infrared (IR) receiver on said media device which is configured for receiving signals from an infrared remote control device.

46. An apparatus as recited in claim 45, wherein said means for communicating selected control signals comprises a circuit configured for detecting said selected control signals being received and encoding said signals upon said power-line communications network for receipt by another media device connected to said power-line communications network.

47. An apparatus as recited in claim 40, wherein said media devices are connected to one another over a power-line communications (PLC) network and configured for receiving operational commands from a media server also coupled to said power-line communication (PLC) network.

48. An apparatus configured for being remotely controlled, comprising:
a media device configured for inputting or outputting video and/or audio streams; and
a power-line communications interface coupled to said media device configured for transferring streaming video and/or audio over a power-line communications (PLC) network for input to said media device, or for output from said media device.

49. An apparatus as recited in claim 48:
further comprising means for receiving operating commands over said power-line communications interface from other devices communicating over said power-line communications (PLC) network;
wherein said operating commands comprise commands directing media input, and/or media output for said media device.

50. An apparatus as recited in claim 48, further comprising means for adjusting input or output latency for said media device to synchronize input or output timing with other media devices also coupled to said power-line communications network.

51. An apparatus as recited in claim 50, wherein said means for adjusting latency comprises a circuit for altering the encoding or decoding latency of a content stream to or from said media device.

52. An apparatus as recited in claim 51, wherein said circuit for altering the encoding or decoding latency is configured to modulate the depth of buffering in response to changes in the encoding or decoding latency.

53. An apparatus as recited in claim 48, further comprising means for executing a plug-in-play interface for communicating operating parameters of said media device over said power-line communications (PLC) interface.

54. An apparatus as recited in claim 48, wherein said media device is selected from the group of media devices consisting essentially of video display devices, audio output devices, video recording devices, video playback devices, audio recording devices, audio playback devices, and combinations thereof.

55. An apparatus for powering electronic devices from an AC power line, comprising:
a housing;
an electrical interface;
a power-supply within said housing configured for converting AC line power to a format suitable for powering an electronics device through said electrical interface; and
a power-line communications interface within said housing configured for communicating data over said electrical interface between said apparatus and other devices which communicate with one another over a power-line communications network.

56. An apparatus as recited in claim 55, wherein said suitable format comprises regulating allowable voltage, current, and supply ripple.

57. An apparatus as recited in claim 55, wherein said housing is configured as a receptacle for physically receiving a portion of said electronics device.

58. An apparatus as recited in claim 55, wherein said power-line communications interface is configured for communicating control data and media streams to and from said electronics device.
